(19) United States
(12) Patent Application Publication
(10) Pub. No.: US 2006/0171701 A1
(43) Pub. Date: Aug. 3, 2006

(54) Lens unit used for camera module having optical filter therein

(75) Inventors: Ho Kyoum Kim, Suwon (KR); Hyoung Woo Nam, Seoul (KR)

Correspondence Address: LOWE HAUPTMAN BERNER, LLP, 1700 DIAGONAL ROAD, SUITE 300, ALEXANDRIA, VA, 22314, US

(73) Assignee: Samsung Electro-Mechanics Co., Ltd., Suwon (KR)

(21) Appl. No.: 11/296,301

(22) Filed: Dec. 8, 2005

(30) Foreign Application Priority Data
Jan. 28, 2005 (KR) 10-2005-00008223

(51) Int. Cl. G03B 7/099

(52) U.S. Cl. 396/275

(57) ABSTRACT

A lens unit for a camera module having an optical filter therein is provided. The lens unit includes a casing, a plurality of lenses, an optical filter, and a fixing member. The casing has a light-receiving hole formed in one side thereof and has a structure in which a cavity is formed. The lenses are aligned in the inside of the casing to transmit light that passes through the light-receiving hole. The optical filter is disposed in the inside of the casing to block a partial wavelength of light and the fixing member maintains the lenses and the optical filter at an aligned state in the inside of the casing. A separate optical filter doesn't need to be mounted in the camera module but is integrally formed in the inside of the casing, so that inflow of foreign substance during the manufacturing process is minimized.

### RELATED APPLICATION

The present application is based on, and claims priority from, Korean Application Number 2005-8223, filed Jan. 28, 2005, the disclosure of which is hereby incorporated by reference herein in its entirety.

### BACKGROUND OF THE INVENTION

1. Field of the Invention

The present invention relates to a lens unit for a camera module used for a camera system of a digital optical apparatus, and more particularly, to a lens unit for a camera module having an optical filter therein, capable of minimizing inflow of foreign substance during a manufacturing process, minimizing the size of a camera module assembly in which an optical filter is mounted, minimizing deterioration of optical performance, and simplifying a manufacturing process by integrally forming an optical filter in the inside of a casing without separately mounting an optical filter on the camera module.

2. Description of the Related Art

Currently, many cellular phone companies develop and produce a cellular phone having a built-in camera module. A variety of built-in camera modules mounted in the cellular phone is under development according to an element and a packaging method thereof.

A camera module 100 used for the cellular phone has an image sensor unit 102 disposed on one side thereof and a connector 130 electrically connected with a main board (not shown) of the cellular phone on the other side thereof. The image sensor unit 102 and the connector 130 are manufactured in a so called chip-on-film (COF) structure in which elements are mounted on a flexible substrate 120.

The image sensor unit 102 has a through hole,124 formed in the flexible substrate 120. The through hole 124 transmits light and has a light-receiving part 150 formed in one side thereof. An image sensor 152 mounted in a flip-chip manner is disposed on one side of the flexible substrate 120 with the light-receiving part 150 exposed through the through hole 124. A packing resin layer 154 is formed around the image sensor 152.

Also, the lens unit 160 is mounted on the flexible substrate 120 to communicate with the light-receiving part 150 through the through hole 124 formed on the front side of the image sensor 152. The lens unit 160 mounts a plurality of lenses 162 on the camera module 100.

In the camera module 100 currently manufactured, an optical filter 170 for filtering a necessary portion in an infrared, an ultraviolet, and a visible ray is an indispensable element.

The optical filter 170 is attached on the flexible substrate 120 within a housing 172 constituting the image sensor unit 102 as illustrated in FIG. 1, directly attached to the image sensor 152 on a printed circuit board (PCB) 180 using a chip-on-board (COB) method as illustrated in FIG. 2A, or attached on the housing 172, which is a lens fixing device, using an adhesive 190 as illustrated in FIG. 2B.

However, in the above conventional methods, when the optical filter 170 is mounted on the upper surface of the flexible substrate 120, mounted on the image sensor 152, or mounted within the housing 172 as described above, foreign substance or an adhesive attaches to or stains the optical filter 170 during a manufacturing process thereof, so that a light receiving operation of the image sensor 152 is disturbed and thus malfunction in the optical performance of the camera module 100 is generated.

Also, since the conventional camera module 100 has the optical filter 170 mounted thereon separately from the lens unit 160, a separate installation structure and manufacturing process for mounting the optical filter 170 is required, so that a manufacturing cost cannot be reduced.

### SUMMARY OF THE INVENTION

Accordingly, the present invention is directed to a lens unit for a camera module having an optical filter therein that substantially obviates one or more problems due to limitations and disadvantages of the related art.

An object of the present invention is to provide a lens unit for a camera module having an optical filter therein, capable of minimizing quality deterioration of a product by minimizing inflow of foreign substance during a manufacturing process.

Another object of the present invention is to provide a lens unit for a camera module having an optical filter therein, that can be applied in designing and manufacturing of a digital apparatus having various structures by lowering the height of an assembly that mounts the optical filter in an image sensor unit.

A further another object of the present invention is to provide a lens unit for a camera module having an optical filter therein, capable of simplifying a manufacturing process thereof by allowing the optical filter to be easily mounted in the inside of an image sensor unit and minimizing quality deterioration of a product.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a lens unit for a camera module having an optical filter therein and used for a digital apparatus, the lens unit including: a casing having a light-receiving hole in one side thereof and having a structure in which a cavity is formed; a plurality of lenses aligned in an inside of the casing to transmit light that passes through the light-receiving hole; an optical filter disposed in the inside of the casing to block a partial wavelength of light; and a fixing member for maintaining the lenses and the optical filter at an aligned state in the inside of the casing.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a sectional view of a camera module having a lens unit according to the related art;

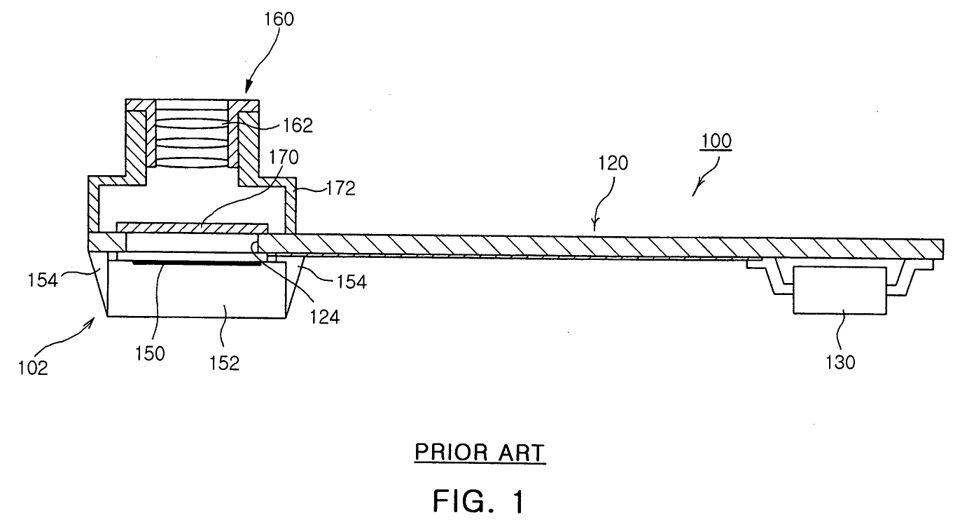

FIG. 2A is a view illustrating an optical filter is attached to an image sensor;

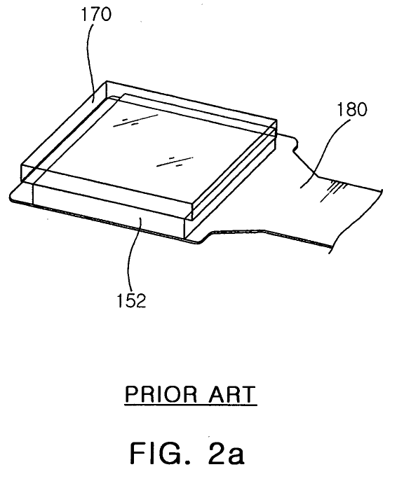

FIG. 2B is a view illustrating an optical filter is attached to a housing using an adhesive;

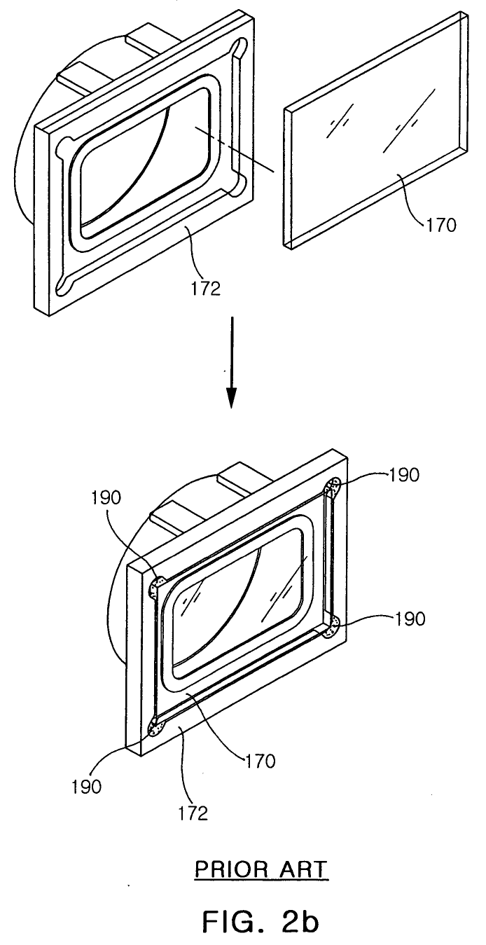

FIG. 3 is a sectional view of a lens unit for a camera module having an optical filter therein according to one embodiment of the present invention;

FIG. 4 is an exploded perspective view of the lens unit for a camera module having an optical filter therein illustrated in FIG. 3;

FIG. 5 is an enlarged sectional view of a lens unit for a camera module having an optical filter therein according to another embodiment of the present invention; and

FIG. 6 is an exploded perspective view of the lens unit for a camera module having an optical filter therein illustrated in FIG. 5.

### DETAILED DESCRIPTION OF THE INVENTION

Reference will now be made in detail to the preferred embodiments of the present invention, examples of which are illustrated in the accompanying drawings.

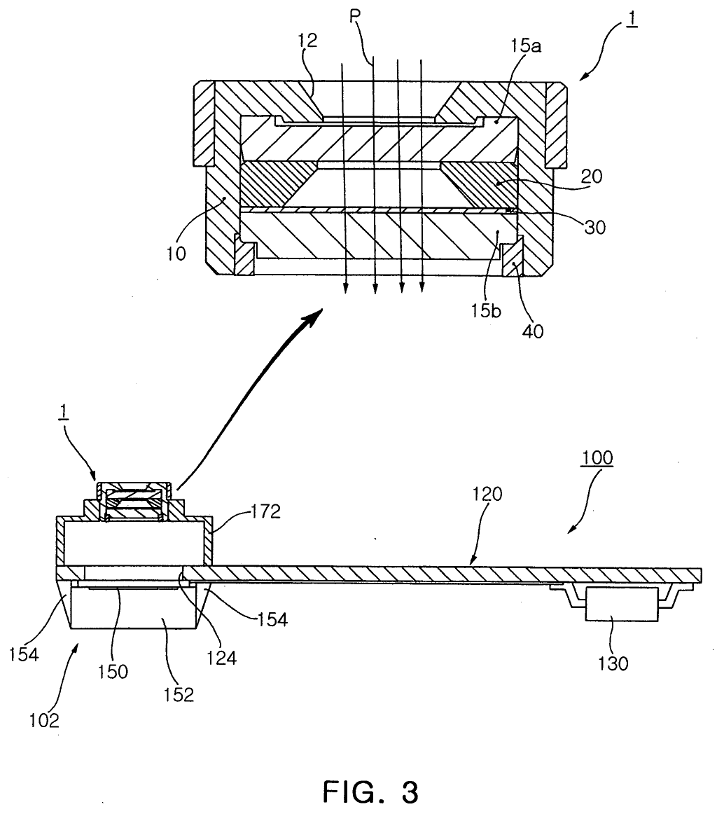

Referring to FIG. 3, a lens unit 1 for a camera module having an optical filter therein according to the present invention is provided to an image sensor unit 102 of a camera module 100 to transmit light to an image sensor 152.

The lens unit 1 includes a casing 10 having a cavity therein. The casing 10 has a cylindrical structure in which a light-receiving hole 12 is formed in one side.

Referring to FIG. 3, the casing 10 has an outer diameter that can be mounted in a housing 172 of the image sensor unit 102. Of course, the casing 10 does not necessarily have a cylindrical shape but can have a polygonal cross-section depending on the shape of the lens used.

The present invention has a plurality of lenses 15a and 15b aligned in the inside of the casing 10, for transmitting light that has passed through the light-receiving hole 12.

FIG. 3 illustrates a structure where the plurality of lenses 15a and 15b are mounted in the inside of the casing 10.

These lenses 15a and 15b are fitted and inserted into the inside from the lower portion of the casing 10.

A spacer 20 is positioned between these lenses 15a and 15b such that a focal length is maintained therebetween.

The spacer 20 has a ring-shaped structure that provides, at the central portion thereof, an optical path P allowing incident light that has passed through the light-receiving hole 12 of the casing 10 to be guided to the rear side without any disturbance.

Therefore, the spacer 20 does not cause any disturbance to the progression of light while light passes through the spacer 20.

Also, the present invention has an optical filter 30 disposed in the inside of the casing 10 to block a partial wavelength of light.

The optical filter 30 may be formed in a film type or formed of thin glass, or a glass material. The optical filter 30 has a thickness ⅕ through ⅓ times smaller than that of the optical filter formed of the conventional glass or plastic.

In the case where the optical filter 30 is formed in a film type, it can be produced like an MOF series by a 3M Co.

As described above, the optical filter 30 blocks all of wavelengths except the wavelength in a required portion of an infrared, an ultraviolet, and a visible ray to perform filtering of light incident to the image sensor 152.

As described above, the optical filter 30 is mounted in the inside of the casing 10 so that the optical filter 30 is integrally formed when the lens unit 1 is manufactured.

Also, the present invention includes a fixing member 40 for maintaining the lenses 15a and 15b and the optical filter 30 at an aligned state in the inside of the casing 10.

The fixing member 40 blocks the lower end of the casing 10 to maintain the lenses 15a and 15b, the optical filter 30, and the spacer 20 in the inside of the casing 10 and has a ring shaped-structure allowing light to pass through the central portion of the fixing member 40 and to be incident to the image sensor 152.

The fixing member 40 can be integrally formed with the casing 10 by fixing the outer periphery of the fixing member 40 to the lower end of the casing 10 in a tight fitting manner or using an adhesive.

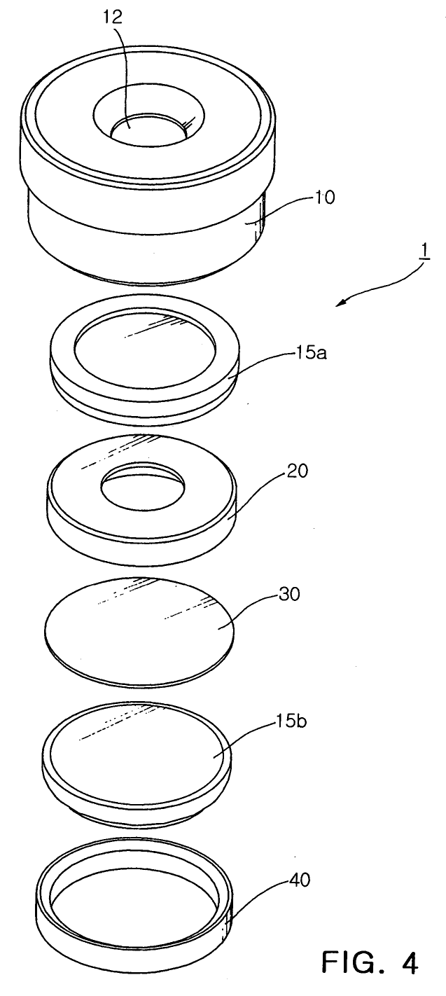

FIG. 4 is an exploded perspective view of the lens unit 1 according to one embodiment of the present invention.

As is revealed by FIG. 4, the optical filter 30 is disposed between the spacer 20 and the second lens 15b. However, it will be obvious to those skilled in the art that the arrangement can be modified in different ways. For example, the optical filter 30 may be disposed between the first lens 15a and the spacer 20.

The fact that the arrangement can be modified is very convenient in designing the lens unit 1. Also, since the thin optical filter 30 is used, the lens unit 1 can be manufactured to have a thin thickness as a whole.

That is, since the optical filter 30 itself is formed in a film type or formed of thin glass, a thickness thereof can be made remarkably thin compared to the conventional optical filter. Also, since the arrangement thereof can be modified freely, the degree of freedom in controlling the thickness of the lenses 15a and 15b, and designing the lenses 15a and 15b can be greatly improved.

Though description of the present invention has been made mainly for the structure in which the plurality of lenses 15a and 15b are provided in the inside of the casing 10 and the optical filter 30 is disposed between the second lens 15b and the spacer 20, the present invention is not limited to the above-descried structure.

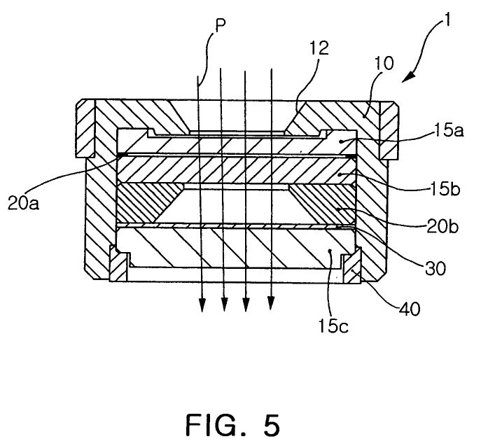

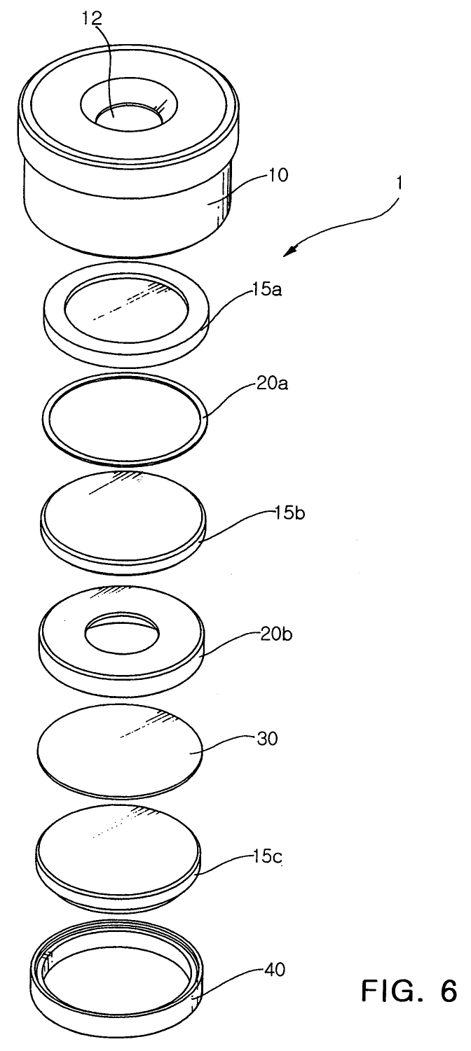

That is, referring to FIGS. 5 and 6, the lens unit 1 may include three lenses 15a, 15b, and 15c disposed in the inside of the casing 10.

In detail, the first lens 15a is fitted and inserted into the inside from the lower portion of the casing 10. Next, the first disk-ring-shaped spacer 20a is fitted and then the second lens 15b is fitted thereon.

The second spacer 20b is disposed after the second lens 15b, and the first and second spacers 20a and 20b have a ring-shaped structure that provides an optical path P at the central portion to allow incident light to pass through a light-receiving hole 12 of the casing 10 and to be guided to the rear side without any disturbance.

Also, the present invention has an optical filter 30 disposed on the rear side of the spacer 20b to block a partial wavelength of light, and subsequently, the third lens 15c is fitted into the inside of the casing 10.

The present invention finally includes a fixing member 40 for maintaining the lenses 15a, 15b, and 15c, and the optical filter 30 at an aligned state in the inside of the casing 10.

As described with reference to FIGS. 3 and 4, the fixing member 40 has a ring-shaped structure that provides an optical path P at the central portion to allow light to pass therethrough and to be incident to an image sensor 152.

Also, the fixing member 40 can be integrally formed with the casing 10 by fixing the outer periphery of the fixing member 40 to the lower end of the casing 10 in a tight fitting manner or using an adhesive.

As is revealed from the above structure, since the optical filter 30 is disposed between the lenses 15a, 15b, and 15c in the inside of the casing 10, the optical filter 30 can be manufactured simultaneously as the partial portion of the lens unit 1.

That is, the optical filter 30 can be disposed between the first lens 15a and the second lens 15b, or between the second lens 15b and the third lens 15c.

Alternatively, unlike the above structure, the optical filter 30 can be disposed between the spacers.

Therefore, the inventive lens unit 1 can have the optical filter 30 manufactured and mounted within the casing 10 regardless of the number of the lenses or the spacers as well as the thickness of the lenses according to design conditions of the camera module in which the lens unit is mounted, so that the degree of freedom in designing the camera module 100 can be greatly improved.

The optical filter 30 mounted within the casing 10 is formed in a film type or formed of thin glass, so that the thickness of the lens unit 1 can be made thin and thus the thickness of the camera module 100 or the digital apparatus in which the lens unit is mounted can be also made thin.

According to the present invention, the optical filter 30 can be mounted within the casing 10 together with the plurality of lenses and integrally manufactured therewith, so that the manufacturing process of the camera module can be remarkably simplified.

The related art adopts an independent mounting structure of fixing the optical filter 170 formed of glass or plastic on the image sensor unit 102 separately from the lens unit. On the contrary, according to the present invention, since such a separate process is omitted and the optical filter 30 can be integrally mounted within the lens unit 1, the manufacturing process of the camera module can be simplified.

Therefore, it is possible remarkably reduce the number of the manufacturing processes of the lens unit 1 and the camera module in which the lens unit 1 is mounted.

Also, according to the present invention, since the thin optical filter 30 is used, the height of the lens unit 1 can be remarkably reduced in comparison with the case where the conventional optical filter 170 formed of glass or plastic is used, and thus the height of the camera module can be also reduced. Therefore, the present invention can provide a design structure that meets a light-weight and a slim profile, which are current market trends in the digital apparatus.

Also, according to the present invention, since the optical filter 30 is interposed in the inside of the casing 10 to constitute the lens unit 1, a separate structure for fixing the optical filter doesn't need to be formed in the camera module. The above-described lens unit having the optical filter therein minimizes many design considerations related to a housing design of the camera module.

Therefore, the design of the camera module and a manufacturing structure thereof are performed in a simple manner, so that the design and the manufacturing are performed easily and conveniently.

Also, according to the present invention, since the optical filter 30 is used and the structure of the inventive camera module is not very different from that of the conventional camera module, the present invention can be applied to both the conventional camera module and the lens unit.

According to the present invention, since the optical filter 30 is used and the separate structure for fixing the optical filter is not required, a manufacturing cost can be remarkably reduced. Therefore, the manufacturing cost of the camera module can be also reduced.

Also, according to the present invention, a process of mounting the optical filter 30 is not complicated and performed simultaneously with a process of assembling the lenses, so that a manufacturing process is simple and the assembling process is easy and thus the possibility that foreign substance is attached on the optical filter 30 or penetrates into the inside of the lens unit is remarkably reduced.

Therefore, it is possible to prevent in advance deterioration of optical performance due to foreign substance or generation of defective product which may occur in the camera module.

Also, according to the present invention, since the optical filter 30 can be easily mounted, the optical filter can be easily applied to a variety of digital cameras or all of the optical apparatus that use lenses.

While the present invention has been particularly shown and described with reference to preferred embodiments thereof, it will be apparent to those skilled in the art that the present invention is not limited to that preferred embodiments but various modifications and variations can be made in the present invention. Thus, it is intended that the present invention covers the modifications and variations of this invention provided they come within the scope of the appended claims and their equivalents.

What is claimed is:

1. A lens unit for a camera module having an optical filter therein and used for a digital apparatus, the lens unit comprising:
a casing having a light-receiving hole in one side thereof and having a structure in which a cavity is formed;
a plurality of lenses aligned in an inside of the casing to transmit light that passes through the light-receiving hole;
an optical filter disposed in the inside of the casing to block a partial wavelength of light; and
a fixing member for maintaining the lenses and the optical filter at an aligned state in the inside of the casing.

2. The lens unit of claim 1, wherein the lenses comprise a plurality of lenses, a spacer is disposed between the lenses, and the optical filter is mounted between one of the lenses and the spacer.

3. The lens unit of claim 1, wherein the lenses comprise at least three lenses, spacers are disposed between the lenses, and the optical filter is mounted between one of the lenses and one of the spacers.

4. The lens unit of claim 3, wherein the optical filter is disposed between the spacers.

5. The lens unit of claim 1, wherein the optical filter is formed in a film type.

6. The lens unit of claim 5, wherein the optical filter has a thickness ⅕ through ⅓ times smaller than that of an optical filter formed of glass or plastic.

7. The lens unit of claim 1, wherein the fixing member has a ring-shaped structure that provides an optical path in a central portion thereof to allow light to pass the optical path and to be incident to an image sensor, and the fixing member is integrally formed with the casing by fixing an outer periphery of the fixing member to a lower end of the casing in a tight fitting manner or using an adhesive.

8. A camera module having the lens unit of claim 1.
